(19) United States
(12) Patent Application Publication
(10) Pub. No.: US 2025/0371977 A1
(43) Pub. Date: Dec. 4, 2025

(54) METHOD AND SYSTEM FOR IDENTIFYING PARKING SPACE, AND DEVICE EMPLOYING METHOD

(71) Applicant: HON HAI PRECISION INDUSTRY CO., LTD., New Taipei (TW)

(72) Inventors: CHIH-CHENG LIU, New Taipei (TW); YU-MING CHIU, New Taipei (TW)

(21) Appl. No.: 18/918,279

(22) Filed: Oct. 17, 2024

(30) Foreign Application Priority Data
May 29, 2024 (CN) 202410681454.3

(51) Int. Cl. G08G 1/14; G06V 20/58

(52) U.S. Cl. CPC G08G 1/143; G06V 20/586

(57) ABSTRACT

A method for identifying parking space includes: receiving a plurality of images of a parking area and a coordinate of a shooting point of each of the plurality of images, wherein a maximum shooting time difference of the plurality of images being within the preset duration; constructing a fusion image of the parking area based on the plurality of images; determining a free parking space based on the fusion image, and determining location information of the free parking space based on the coordinate of the shooting point of each of the plurality of images. By fusing multiple images of the parking area, the fusion image containing the plurality of images of the parking area can be obtained, to identify the parking space and improve the availability and reliability of the fusion image. A system for identifying parking space and an electronic device are also provided.

### TECHNICAL FIELD

The subject matter herein generally relates to parking space identification.

### BACKGROUND

In recent years, the number of vehicles has gradually increased, while parking spaces are limited in many places. Drivers are often required to search for a parking space while driving, which may cause drivers to be distracted and hit obstacles or pedestrians.

### BRIEF DESCRIPTION OF THE DRAWINGS

Implementations of the present technology will now be described, by way of example only, with reference to the attached figures.

FIG. 1 is a structure diagram of a system for identifying parking spaces in one embodiment of the present application.

FIG. 2 is an application scenario diagram of the system for identifying parking spaces in one embodiment of the present application.

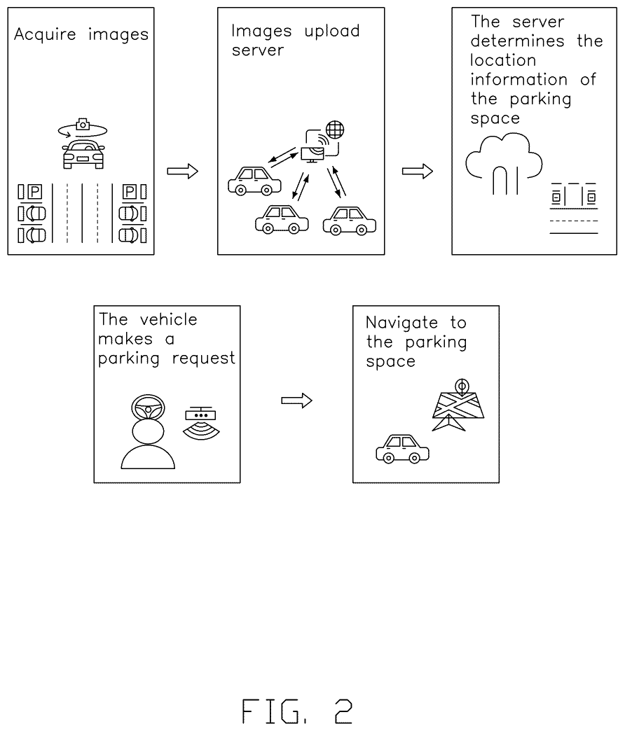

FIG. 3 is an application scenario diagram of determining parking areas of the system for identifying parking spaces in one embodiment of the present application.

FIG. 4 is an application scenario diagram of detecting occlusions of the system for identifying parking spaces in one embodiment of the present application.

FIG. 5 is a flow diagram of a method for identifying parking spaces in one embodiment of the present application.

FIG. 6 is a flow diagram of constructing a fusion image in one embodiment of the present application.

FIG. 7 is a comparison diagram of before image fusion and after image fusion in one embodiment of the present application.

FIG. 8 is a comparison diagram of before image fusion and after image fusion in another embodiment of the present application.

FIG. 9 is a flow diagram of high frequency fusion and low frequency fusion in one embodiment of the present application.

FIG. 10 is a flow diagram of the method for identifying parking spaces in another embodiment of the present application.

FIG. 11 is a flow diagram of the method for identifying parking spaces in another embodiment of the present application.

FIG. 12 is an application scenario diagram of coordinate conversion of the method for identifying parking spaces in one embodiment of the present application.

FIG. 13 is a structure diagram of an electronic device in one embodiment of the present application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the targets are permanently connected or releasably connected. The term “comprising,” when utilized, means “including, but not necessarily limited to”; it specifically indicates open-ended inclusion or membership in the so-described combination, group, series, and the like.

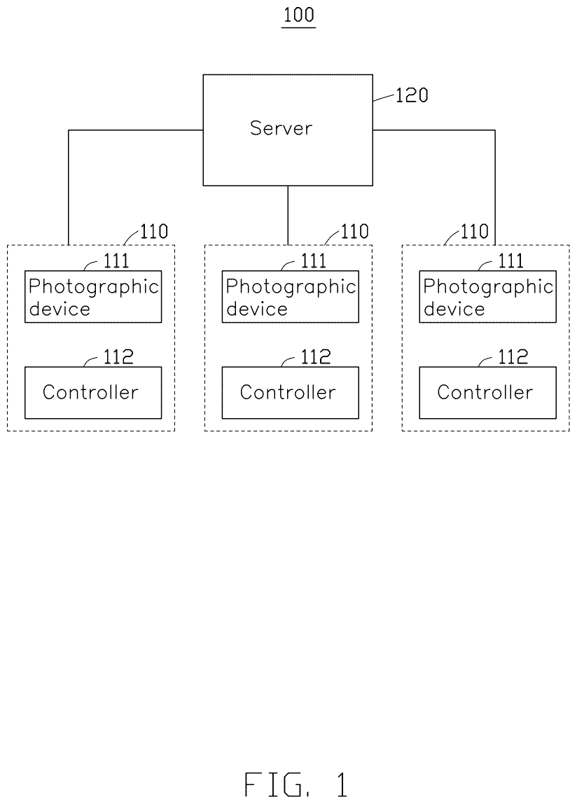

FIG. 1 is a structure diagram of a system for identifying parking spaces in one embodiment of the present application. The system 100 includes a plurality of vehicles 110 and a server 120. The plurality of vehicles 110 are configured to capture image of the parking area. The server 120 is configured to receive a plurality of images uploaded by the plurality of vehicles 110 and receive a coordinate of each of the plurality of vehicle 110 when capturing image. A maximum shooting time difference of the plurality of images is within a preset duration. The server 120 is further configured to construct a fusion image of the parking area based on the plurality of images, determine a free parking space based on the fusion image, and determine location information of the free parking space based on the coordinate of each of the plurality of vehicle 110 when capturing image.

In one embodiment, the vehicle 110 includes a photographic device 111 and a controller 112. The photographic device 111 is configured to capture images of a target area. The controller 112 is configured to pre-process the images information captured by the photographic device 111 and obtain an image of the parking area.

In one embodiment, the plurality of vehicles 110 can be in different positions, and the plurality of vehicles 110 can obtain images of the parking area at different angles through the photographic device 111 installed on them, so that the server 120 can identify the parking space in the parking area more accurately. The server 120 can fuse the plurality of images of the parking area to obtain a fusion image containing the plurality of images of the parking area. Then the server 120 can analyze the fusion image to determine the parking space information of the parking area. For example, the server 120 can determine a parking space by detecting parking space information such as parking grid lines and parking signs in the fusion image. If parking grid lines and/or parking signs exist in the fusion image, the server 120 can determine that a parking space exists in the parking area. If no parking grid lines and/or parking signs exist in the fusion image, the server 120 can determine that no parking space exists in the parking area.

After determining that a parking space exists in the parking area, the server 120 can further determine the location information of the parking space. For example, the server 120 can determine the distance between the first vehicle 110 and the second vehicle 110 based on the first coordinate of the first vehicle 110 and the second coordinate of the first vehicle 110. The first observation angle of the first vehicle 110 relative to the parking space can be determined according to the first image collected by the first vehicle 110, and the second observation angle of the second vehicle 110 relative to the parking space can be determined according to the second image information collected by the second vehicle 110. The coordinate of the parking space can be obtained by using the principle of triangulation. After that, the server 120 can store the coordinate of the parking space, or send the coordinate of the parking space to the car terminal when receiving a parking request, thus providing a parking place for the car terminal, and guiding the driver to find the parking space. Alternatively, the server 120 can also recognize the parking space number in the fusion image and send the parking space number to the car terminal to guide the driver to find the parking space. In this way, the driver can directly navigate to the parking space according to the location information of the parking space provided by the server 120, so as to avoid the distraction of the driver when looking for a parking space, improve driving safety, and reduce the time required to find a parking space.

In one embodiment, the images of the parking area sent by the vehicle 110 to server 120 also includes a time stamp which can be used for the server 120 to select eligible image information. The server 120 can perform data pre-processing and buffer management on the plurality of images of the parking area according to time series. For example, confirming the integrity, length, and content of the plurality of images of the parking area.

If the time interval between the plurality of images is large, the fused images may contain useless image information. Therefore, by obtaining the plurality of images of the parking area within the preset time range for fusion, and unifying the time series of the plurality of images for fusion, the accuracy of the fusion image can be improved, and the accuracy of parking space identification can be guaranteed. The preset duration can be set as required, for example, 1 second, 2 seconds, or 3 seconds.

Furthermore, the image of the parking area sent by the vehicle 110 to the server 120 can also include the coordinate information of the vehicle 110 of the current time. If the locations of the plurality of vehicles 110 are far apart when taking images, the fused images may contain images with interference areas. Therefore, the server 120 can also fuse the plurality of images within the preset range according to the coordinates of the plurality of vehicles 110 to improve the accuracy of the fused image. Among them, the preset coordinate range can be set according to the actual needs to reduce the interference image in the plurality of images used for fusion.

In one embodiment, the photographic device 111 can be installed on the headlights, rearview mirrors, and keyholes of the rear trunk of the vehicle 110. The photographic device 111 can be a camera with imaging function.

The photographic device 111 can acquire many images over a period of time. If all of the images are sent to the server 120 for analysis and processing, the operating burden of server 120 will be large. Therefore, the images obtained by the photographic device 111 can be preprocessed by the controller 112. For example, the images of the target area are analyzed to screen out the images containing parking space information or the images with high definition. Then the pre-processed images are sent to the server 120, so that the server 120 can directly process the received images, thus reducing the traffic required for uploading to the cloud, and reducing the storage space and processing speed required by the server 120.

In one embodiment, each of the plurality of vehicles 110 can be configured to: capture images of a target area, determine parking area and non-parking area of the target area based on the images of the target area, retain the images of the parking area and removing the images of the non-parking area, determine whether an occlusion exists in the parking area based on the images of the parking area, retain the images of the parking area if the occlusion does not exist in the parking area, and remove the images of the parking area if the occlusion exists in the parking area.

Among them, the images of the target area can be collected by the photographic device 111 on the vehicle 110 or by the photographic device 111 fixed near the target area. The target area can be divided according to the practical application. For example, a plurality of target areas can be divided according to driving path of the plurality of vehicles 110, so that the vehicle 110 can collect images of the target area during the driving process.

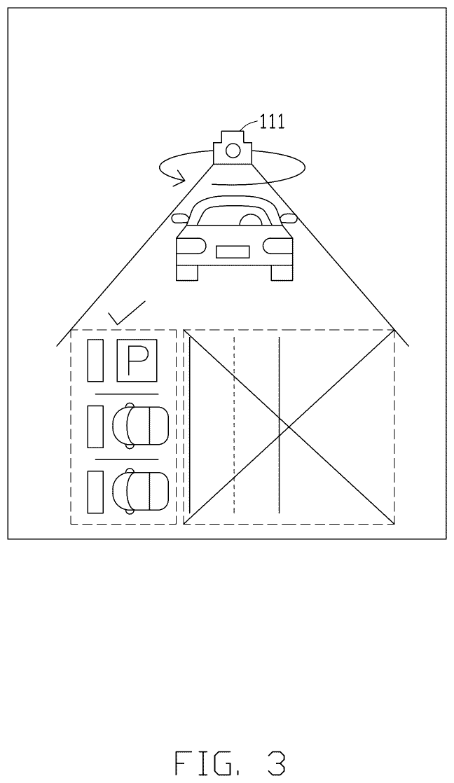

Referring to FIG. 3, the parking area and a non-parking area can be distinguished according to the corresponding object characteristics. For example, an area containing parking grids and parking signs can be defined as a parking area, and an area containing safety islands, lane lines, traffic signs, and street lights can be defined as a non-parking area. The image processing efficiency can be improved by keeping the image information of the parking area that is needed and removing the image information of the non-parking area that is not needed.

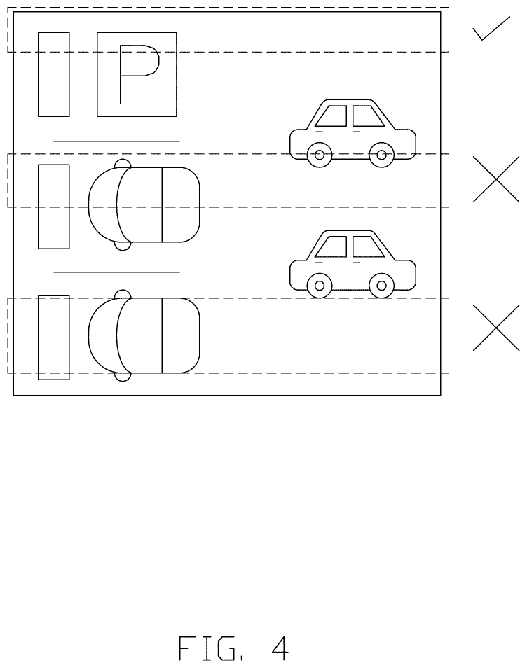

Referring to FIG. 4, detection of occlusions can be performed according to the characteristics of occlusions that may exist in practical applications. For example, occlusions can be pedestrians, other vehicles, barricades, and so on. If an occlusion is detected, indicating that the parking space may have been occupied, or the parking space may be temporarily blocked by pedestrians or other vehicles, and the parking space information cannot be accurately judged. Therefore, the image with occlusions cannot be output as the image of the parking area. If no occlusion is detected, indicating that there may be available parking space in the parking area, which can be output as an image of the parking area.

By fusion of the plurality of images of the parking area, a fusion image containing the plurality of images of the parking area can be obtained, so that the server 120 can identify the parking space through the fusion image, improving the availability and reliability of the fusion image. Then the location information of the parking space can be determined according to the coordinates of the shooting point of each image and the output to the car terminal. In this way, the driver can directly navigate to the parking space according to the coordinates provided by the server 120, avoiding the distraction of the driver to find a parking space, improving driving safety, and reducing the time required to find a parking space.

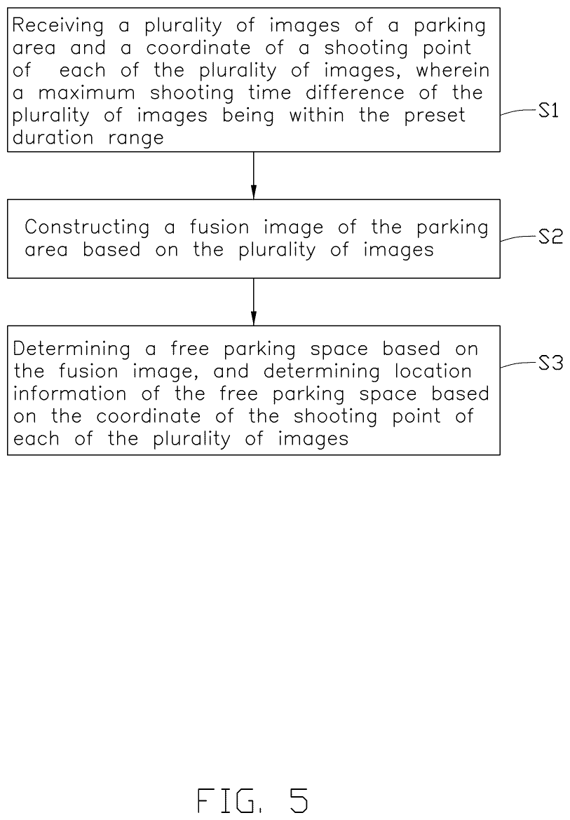

FIG. 5 is a flow diagram of a method for identifying parking space in one embodiment of the present application. The method can include the following blocks:

In block S1: a plurality of images of a parking area and a coordinate of a shooting point of each of the plurality of images are received, and a maximum shooting time difference of the plurality of images is within the preset duration.

In one embodiment, the plurality of images of the parking area can be taken from different angles to make the image information of the parking area more complete and improve the accuracy of parking space identification. The image of the parking area can be obtained by a photographic device 111 on the vehicle 110, or by a photographic device 111 fixed near the parking area.

Each image of the parking area also includes a time stamp. The plurality of images of the parking area can be processed and buffered according to time series. For example, confirming the integrity, length, and content of the plurality of images of the parking area, so as to prepare for the image fusion.

If the time interval between the plurality of images is large, the fused images may contain useless image information. Therefore, by obtaining the plurality of images of the parking area within the preset time range for fusion, and unifying the time series of the plurality of images for fusion, the accuracy of the fusion image can be improved, and the accuracy of parking space identification can be guaranteed. The preset duration can be set as required, for example, 1 second, 2 seconds, or 3 seconds.

In block S2: a fusion image of the parking area is constructed based on the plurality of images.

In one embodiment, the plurality of images of the parking area can be fused to obtain a fusion image containing the plurality of images of the parking area. Then the fusion image is used to identify the parking space to improve the efficiency and accuracy of parking space recognition.

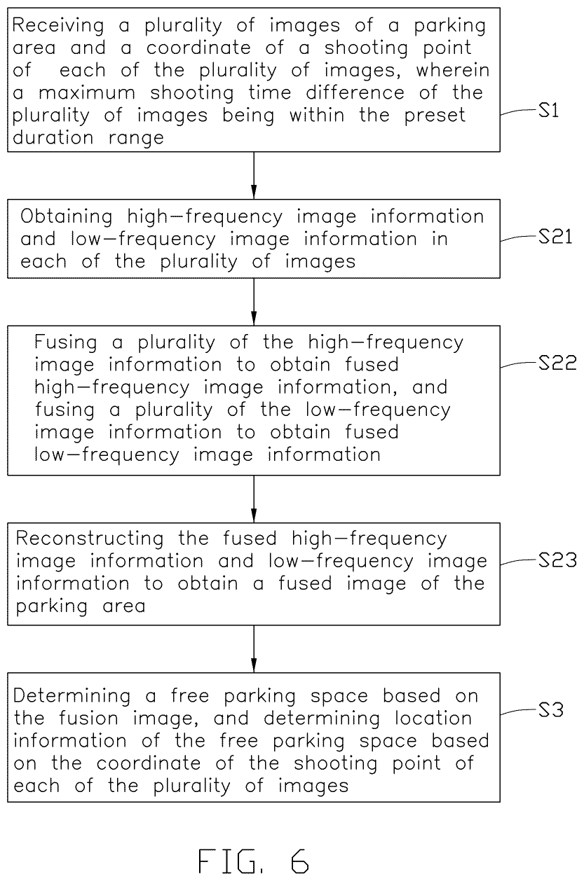

Referring to FIG. 6, in one embodiment, block S2 of constructing the fusion image of the parking area based on the plurality of images may include blocks S21˜S23.

In block S21: high-frequency image information and low-frequency image information are obtained in each of the plurality of images.

In one embodiment, the color of each pixel in the image can be represented by a color value. Sampling a plurality of pixels obtaining a plurality of sample color values. Then, converting the plurality of sampling color values into signals in the frequency domain to obtain a plurality of frequency signals. For an image, the frequency can represent the speed of gray change. The low frequency indicates that the gray level changes slowly, that is, the color changes slowly, usually indicating a continuous gradient of an area. The high frequency indicates that the gray level changes quickly, that is, the gray level difference between adjacent regions is large, and usually indicates the edge of the image. For example, the color difference between the edge of a person and the background in the image is usually large, and this is the high-frequency part. The parts within the edge of the person usually have less color difference, and this is the low frequency part.

After that, the plurality of frequency signals are filtered to obtain the high frequency signals that represent the high frequency image information and the low frequency signals that represent the low frequency image information.

For example, a discrete wavelet transform can be performed to obtain a high frequency signal and a low frequency signal according to the following formula:

$$\begin{matrix}{x}_{a , L} ( n ) = {\sum }_{K = 0}^{K - 1} {x}_{a - 1 , L} ( 2 n - k ) g ( k ) \\ {x}_{a , H} ( n ) = {\sum }_{K = 0}^{K - 1} {x}_{a - 1 , H} ( 2 n - k ) h ( k )\end{matrix}$$

Among them, X_{a,L} is the input signal, g(k) is the low-pass filter, h(k) is the high-pass filter, n is the number of sampling pixels, k is the frequency. The frequency range of the high frequency signals and the frequency range of the low frequency signals can be set according to the actual needs to distinguish the parking area and the occlusion.

In image fusion, the spatial resolution of images from different sources may be different. Discrete wavelet transform can convert images into wavelet subbands with different frequencies, which can be fused in different frequency subbands to solve the problem of different spatial resolutions. The more times the discrete wavelet transform is performed, the smoother the image is, but the more distorted it is. The number of discrete wavelet transform can be set according to the requirement, so that the fused image can achieve the required recognition.

In block S22: a plurality of the high-frequency image information are fused to obtain fused high-frequency image information, and fusing a plurality of the low-frequency image information to obtain fused low-frequency image information.

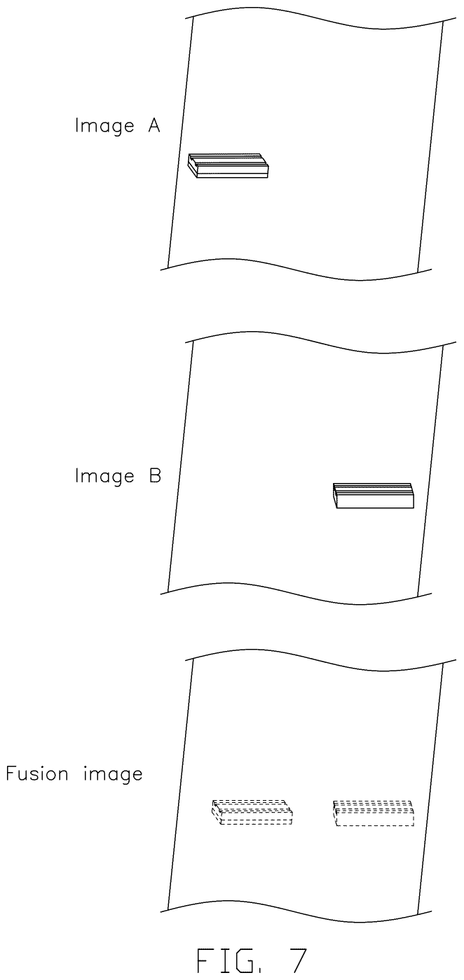

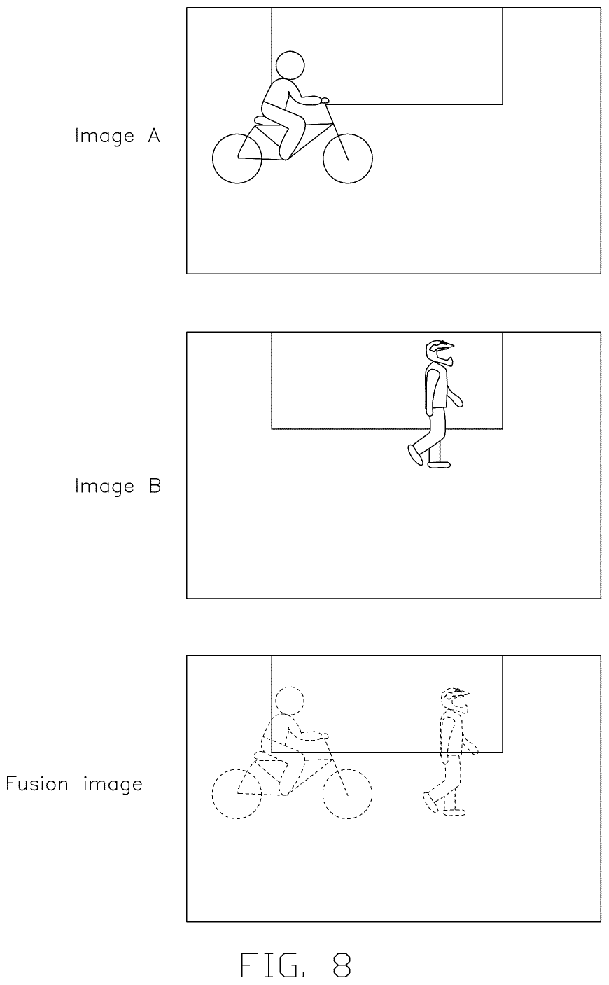

In one embodiment, the fusion of high-frequency image and the fusion of low-frequency image information can be used to form the fusion image of the parking area. In this way, the corresponding low frequency features and high frequency features in the plurality images can be included in the fused image. The fused image can be referred in FIG. 7 and FIG. 8.

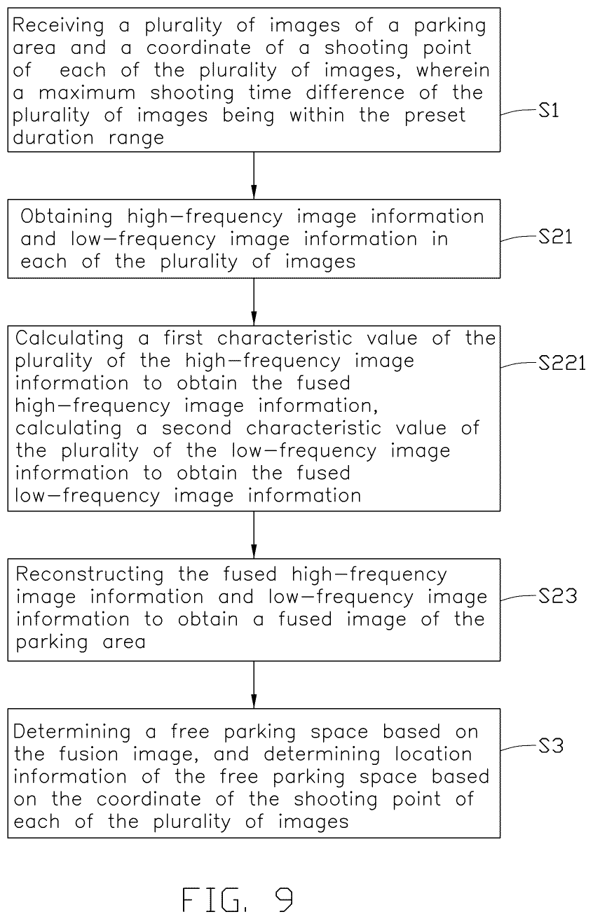

Referring to FIG. 9, in one embodiment, the block S22 of fusing a plurality of the high-frequency image information to obtain fused high-frequency image information, and fusing a plurality of the low-frequency image information to obtain fused low-frequency image information may include block S221.

In block S221: a first characteristic value of the plurality of the high-frequency image information is calculated to obtain the fused high-frequency image information, calculating a second characteristic value of the plurality of the low-frequency image information to obtain the fused low-frequency image information.

In one embodiment, the characteristic value includes any of the average value, maximum value, minimum value and weighted average value, and the appropriate fusion strategy can be selected according to the requirements of image fusion to preserve the important information in the original image. When image fusion is performed, the frequency of the low-pass filter and the frequency of high-pass filter of the discrete wavelet transform can be adjusted to provide different frequency subbands. Each frequency subband can provide a different spatial resolution, so that a suitable fusion method can be selected for each subband to achieve more accurate image fusion. In addition, the image information transformed by discrete wavelet can be restored to the original image through discrete wavelet reversal, which means that there will be no information loss in the fusion process, so as to ensure the integrity of the fusion result and improve the accuracy of parking space identification.

For example, the average of the plurality of high-frequency signals is calculated to obtain a fused high-frequency signal. The average value of the plurality of low frequency signals is calculated to obtain the fusion low-frequency signal. In this way, high frequency features and low frequency features of the plurality of images are retained in the fused image, and the plurality of images can present the same transparency in the fused image. In the case of complex image composition of the overall environment and obstacles, more details and acceptable identification rate of parking space status can be saved after average fusion, so as to identifying whether the parking space is occupied. Or, in other application scenarios, the maximum value of the plurality of high-frequency signals can be taken, and the parts with the maximum high-frequency signals in the plurality of images are retained, which can improve the discrimination rate after fusion. Alternatively, taking the minimum value of the plurality of high-frequency signals, and preserving the part with the minimum high-frequency signals in the plurality of images, to reduce the discrimination rate after fusion. Alternatively, according to the images that need to be retained, different weights can be assigned to the plurality of high-frequency signals. The same applies to the calculation of multiple low-frequency signals.

In block S23: the fused high-frequency image information and low-frequency image information are reconstructed to obtain a fused image of the parking area.

In one embodiment, the fusion of high-frequency image information and the fusion of low-frequency image information can be reconstructed by discrete wavelet inversion:

$$\begin{matrix}det ( {H}_{m} ( z ) ) = G ( z ) H ( - z ) - H ( z ) G ( - z ) \\ ( \begin{matrix}{G}_{1} ( z ) \\ {H}_{1} ( z )\end{matrix} ) = \frac{2}{det ( {H}_{m} ( z ) )} ( \begin{matrix}H ( z ) \\ - G ( - z )\end{matrix} ) .\end{matrix}$$

Among them, G(z) is Z conversion for low-pass filter, H(z) is Z conversion for high-pass filter. The Z transform transforms the time domain signal (i.e. discrete time series) into the complex frequency domain.

In block S3: a free parking space is determined based on the fusion image, and determining location information of the free parking space based on the coordinate of the shooting point of each of the plurality of images.

In one embodiment, the location information of the free parking space includes the coordinates of the free parking space and/or the number of the free parking space. After determining that there is a parking space in the parking area, the location information of the parking space can be further determined. For example, the coordinate of the shooting point of the first image is the first coordinate, and the coordinate of the shooting point of the second image is the second coordinate. According to first coordinate and the second coordinate, the distance between the shooting point of the first image and the shooting point of the second image can be determined. The first observation angle of the shooting point of the first image relative to the parking space can be determined according to the first image, and the second observation angle of the shooting point of the second image relative to the parking space can be determined according to the information of the second image. The coordinate of parking space can be obtained by using the principle of triangulation.

After that, the coordinate of the parking space can be stored or sent to the driver to provide a parking place for the driver who needs parking, and guide the driver to find a parking space. Alternatively, the parking space number in the fusion image can be recognized and sent to the driver to guide the driver to find the parking space. In this way, the driver can receive the location information of the parking space to directly navigate to the parking space, avoiding the driver to distract to find a parking space, improving driving safety, and reduce the time required to find a parking space.

In one embodiment, the block S3 of determining a free parking space based on the fusion image may include block S31.

In block S31: the fusion image is inputted into a pre-trained recognition model to determine the free parking space, the recognition model is trained based on historical parking space images.

In one embodiment, a preset training model can be trained by marking the historical parking space pictures containing a parking space as correct, and marking the historical parking space pictures that does not contain a parking space or the parking space being obscured as wrong. Then the fused image is input into the preset training model. If the output result is correct, determining that the parking space exists in the parking area. If the output result is false, determining that there is no parking space in the parking area, and the parking space identification process can be ended or the next parking space identification can be continued.

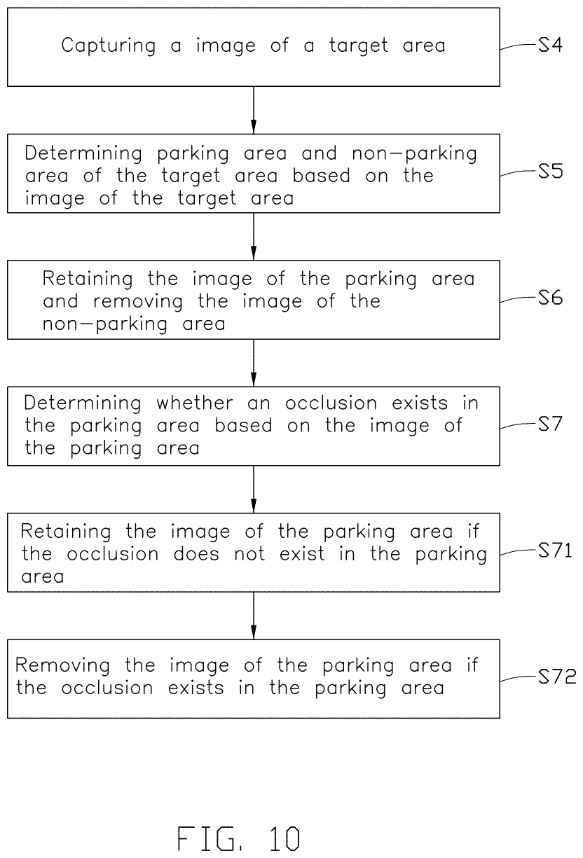

Referring to FIG. 10, the method further includes blocks S4˜S7.

In block S4: images of a target area are captured.

In one embodiment, the image of the target area can be captured by a photographic device 111 on the vehicle 110 or by a photographic device 111 fixed near the target area. The target area can be divided according to the practical application, for example, target areas can be divided according to the driving path of the vehicle 110, so that the vehicle 110 can collect images of target areas during the driving process.

In block S5: parking area and non-parking area of the target area are determined based on the images of the target area.

Referring to FIG. 3, the parking area and non-parking area can be distinguished according to the corresponding object characteristics. For example, an area containing parking grids and parking signs can be defined as a parking area, and an area containing safety islands, lane lines, traffic signs, and street lights can be defined as a non-parking area.

In block S6: the images of the parking area is retained and the images of the non-parking area is removed.

In order to determine the available parking space, further analysis of the parking area is required. Therefore, only the needed parking area image information is retained, and the unnecessary non-parking area image information is removed to improve the image processing efficiency.

In block S7: whether an occlusion exists in the parking area is determined based on the images of the parking area.

Referring to FIG. 4, detection of occlusions can be performed according to the characteristics of occlusions that may exist in practical applications. For example, occlusions can be pedestrians, other vehicles, barricades, and so on.

In block S71: the images of the parking area are retained if the occlusion does not exist in the parking area.

In block S72: the images of the parking area are removed if the occlusion exists in the parking area.

If an occlusion is detected, indicating that the parking space may have been occupied, or the parking space may be temporarily blocked by pedestrians or other vehicles, and the parking space information cannot be accurately judged. Therefore, the images with occlusions cannot be output as the images of the parking area. If no occlusion is detected, indicating that there may be available parking space in the parking area, which can be output as images of the parking area.

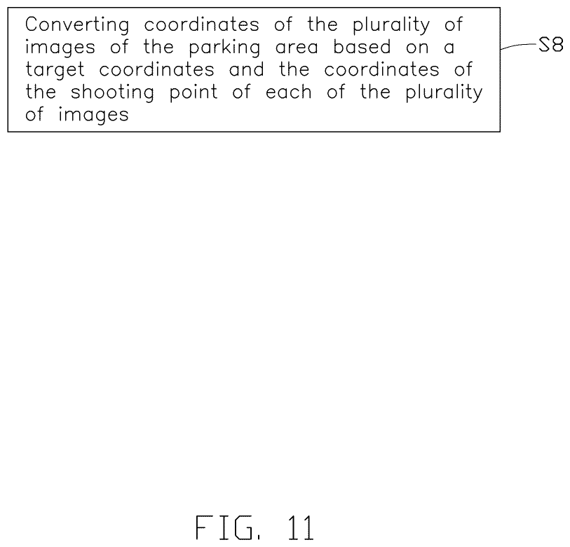

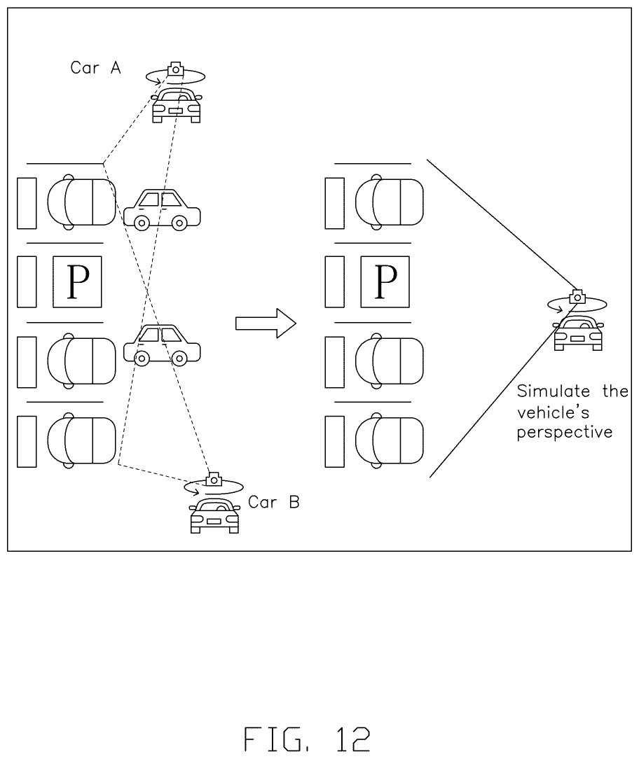

Referring to FIG. 11 and FIG. 12, the method further includes block S8.

In block S8: coordinates of the plurality of images of the parking area are converted based on a target coordinate and the coordinate of the shooting point of each of the plurality of images.

Since the images of the parking area can be obtained from different angles, overlapping shadows may appear after fusion. Therefore, linear transformation can be used to convert the coordinates of the image of the parking area according to the target coordinate and the coordinate of image shooting points, so as to unify the coordinate systems of the plurality of images, avoid the phenomenon of overlapping shadows, and improve the accuracy of parking space identification. The target coordinate can be set according to the practical application, for example, set to the middle position of the coordinates of the plurality of shooting points. Steps S8 may be performed after any of the steps S1 through S7, and this application is not limited herein.

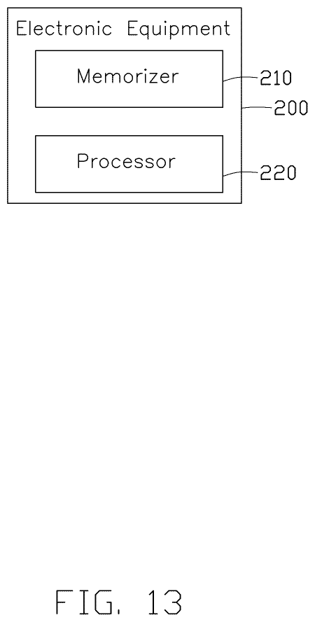

FIG. 13 is a structure diagram of an electronic device 200 in one embodiment of the present application. The electronic device 200 comprises a memorizer 210 and a processor 220. The memorizer 210 is configured to store program instructions. The processor 220 is configured to read and execute the program instructions stored in the memorizer 210. When the program instructions are executed by the processor, causes the electronic device to perform the method for identifying parking space.

Among them, the program instruction includes the computer program code, the computer program code can be source code form, object code form, executable file or some intermediate form. The electronic device 200 can include electric vehicles, mobile terminals, roadside communication devices, etc.

The application also provides a computer-readable storage medium, which stores program instructions and, when the program instructions are run on the electronic device, causes the electronic device to perform the method for identifying parking space.

Among them, the program instruction includes the computer program code, the computer program code can be source code form, object code form, executable file or some intermediate form. The computer-readable storage medium may include: any entity or device capable of carrying computer program code, recording medium, USB flash drive, portable hard drive, magnetic disk, optical disc, computer memory, ROM (Read Only Memory), RAM (Random Access Memory), electric carrier signal, telecommunication signal, and software distribution medium, etc. It should be noted that the contents of the computer readable media may be appropriately increased or decreased according to the requirements of the legislation and patent practice in the jurisdiction, for example, in some jurisdictions, according to the legislation and patent practice, the computer-readable storage medium does not include carrier signals and telecommunications signals.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A method for identifying parking spaces, comprising:
receiving a plurality of images of a parking area and a coordinate of a shooting point of each of the plurality of images, wherein a maximum shooting time difference of the plurality of images is within a preset duration;
constructing a fusion image of the parking area based on the plurality of images;
determining an available parking space based on the fusion image, and determining location information of the free parking space based on the coordinate of the shooting point of each of the plurality of images.

2. The method of claim 1, wherein constructing the fusion image of the parking area based on the plurality of images comprises:
obtaining high-frequency image information and low-frequency image information in each of the plurality of images;
fusing a plurality of the high-frequency image information to obtain fused high-frequency image information, and fusing a plurality of the low-frequency image information to obtain fused low-frequency image information;
reconstructing the fused high-frequency image information and the fused low-frequency image information to obtain the fused image of the parking area.

3. The method of claim 2, wherein fusing the plurality of the high-frequency image information to obtain the fused high-frequency image information, and fusing the plurality of the low-frequency image information to obtain the fused low-frequency image information comprises:
calculating a first characteristic value of the plurality of the high-frequency image information to obtain the fused high-frequency image information;
calculating a second characteristic value of the plurality of the low-frequency image information to obtain the fused low-frequency image information, wherein
each of the first characteristic value and the second characteristic value comprises one of an average value, a maximum value, a minimum value, and a weighted average value.

4. The method of claim 1, wherein determining the free parking space based on the fusion image comprises:
inputting the fusion image into a pre-trained recognition model to determine the free parking space, the recognition model is trained based on historical parking space images.

5. The method of claim 1, further comprising:
capturing images of a target area;
determining a parking area and a non-parking area of the target area based on the images of the target area;
retaining images of the parking area and removing images of the non-parking area;
determining whether an occlusion is present in the parking area based on the images of the parking area;
retaining the images of the parking area if the occlusion is not present in the parking area;
removing the images of the parking area if the occlusion is present in the parking area.

6. The method of claim 1, wherein the location information of the free parking space comprises coordinates of the free parking space and/or a number of the free parking space.

7. The method of claim 1, further comprising:
converting coordinates of the plurality of images of the parking area based on a target coordinate and the coordinate of the shooting point of each of the plurality of images.

8. A system for identifying parking space, comprising:
a plurality of vehicles configured to capture images of a parking area; and
a server configured to receive the images captured and uploaded by the plurality of vehicles and receive a coordinate of each of the plurality of vehicles when the plurality of vehicles capturing the images, wherein a maximum shooting time difference of the plurality of images being within a preset duration, wherein
the server is further configured to construct a fusion image of the parking area based on the plurality of images, determine a free parking space based on the fusion image, and determine location information of the free parking space based on the coordinate of each of the plurality of vehicles when capturing image.

9. The system of claim 8, wherein each of the plurality of vehicles is configured to:
capture images of a target area;
determine a parking area and a non-parking area of the target area based on the images of the target area;
retain the images of the parking area and removing the images of the non-parking area;
determine whether an occlusion exists in the parking area based on the images of the parking area;
retain the images of the parking area if the occlusion does not exist in the parking area;
remove the images of the parking area if the occlusion exists in the parking area

10. An electronic device comprising a memorizer and a processor, wherein the memorizer is configured to store program instructions, the processor is configured to read and execute the program instructions stored in the memorizer, when the program instructions are executed by the processor, causes the electronic device to:
receive a plurality of images of a parking area and a coordinate of a shooting point of each of the plurality of images, wherein a maximum shooting time difference of the plurality of images is within a preset duration;
construct a fusion image of the parking area based on the plurality of images;
determine a free parking space based on the fusion image, and determining location information of the free parking space based on the coordinate of the shooting point of each of the plurality of images.

11. The electronic device of claim 10, wherein when the program instructions are executed by the processor, further causes the electronic device to:
obtain high-frequency image information and low-frequency image information in each of the plurality of images;
fuse a plurality of the high-frequency image information to obtain fused high-frequency image information, and fusing a plurality of the low-frequency image information to obtain the fused low-frequency image information;
reconstruct the fused high-frequency image information and low-frequency image information to obtain a fused image of the parking area.

12. The electronic device of claim 11, wherein when the program instructions are executed by the processor, further causes the electronic device to:
calculate a first characteristic value of the plurality of the high-frequency image information to obtain the fused high-frequency image information;
calculate a second characteristic value of the plurality of the low-frequency image information to obtain the fused low-frequency image information;
the first characteristic value and the second characteristic value both comprises one of an average value, a maximum value, a minimum value, and a weighted average value.

13. The electronic device of claim 10, wherein when the program instructions are executed by the processor, further causes the electronic device to:
input the fusion image into a pre-trained recognition model to determine the free parking space, the recognition model is trained based on historical parking space images.

14. The electronic device of claim 10, wherein when the program instructions are executed by the processor, further causes the electronic device to:
capture images of a target area;
determine a parking area and a non-parking area of the target area based on the images of the target area;
retain the images of the parking area and removing the images of the non-parking area;
determine whether an occlusion exists in the parking area based on the images of the parking area;
retain the images of the parking area if the occlusion does not exist in the parking area;
remove the images of the parking area if the occlusion exists in the parking area.

15. The electronic device of claim 10, wherein the location information of the free parking space comprises coordinates of the free parking space and/or a number of the free parking space.

16. The electronic device of claim 10, wherein when the program instructions are executed by the processor, further causes the electronic device to:
convert coordinates of the plurality of images of the parking area based on a target coordinate and the coordinate of the shooting point of each of the plurality of images.
